(19) United States
(12) Patent Application Publication
(10) Pub. No.: US 2016/0071486 A1
(43) Pub. Date: Mar. 10, 2016

(54) IMMERSIVE PROJECTION LIGHTING ENVIRONMENT

(71) Applicant: Cisco Technology, Inc., San Jose, CA (US)

(72) Inventors: Charles Calvin Byers, Wheaton, IL (US); Matthew A. Laherty, Bloomington, IN (US); Luis O. Suau, Davie, FL (US)

(21) Appl. No.: 14/481,234

(22) Filed: Sep. 9, 2014

(51) Int. Cl. G09G 5/10; G06F 3/01; G06T 11/60; G06F 3/00

(52) U.S. Cl. CPC G09G 5/10; G06F 3/005; G06F 3/017; G06T 11/60; G09G 2370/02

(57) ABSTRACT

In one embodiment, a method comprises transmitting, by an access network light fixture, scene information to a light fixture control server, the scene information being associated with a scene detected by one or more cameras associated with the access network light fixture, the scene being within a vicinity of the access network light fixture; receiving, by the access network light fixture, rendering information based on the scene information from the light fixture control server; and controlling, by the access network light fixture, projection of an image overlying the scene and projected by one or more image projectors associated with the access network light fixture based on the rendering information received from the light fixture control server.

### TECHNICAL FIELD

The present disclosure generally relates to providing an immersive projection lighting environment via a networked light fixture.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

Light as a Service (LaaS) is a growth area in the Internet of Everything. In LaaS installations, traditional light fixtures are replaced with Internet-controlled light sources.

### BRIEF DESCRIPTION OF THE DRAWINGS

Reference is made to the attached drawings, wherein elements having the same reference numeral designations represent like elements throughout and wherein:

FIG. 1 illustrates a system having an apparatus for providing networked control over radiation emitted by the apparatus, according to an example embodiment.

FIG. 2 illustrates an example implementation of any of the apparatus of FIG. 1, according to an example embodiment.

FIG. 3 illustrates in further detail the apparatus of FIG. 1, according to an example embodiment.

FIG. 4 illustrates in further detail the apparatus of FIG. 1, according to an alternative example embodiment.

FIG. 5 illustrates control of two access network light fixtures, according to an example embodiment.

FIGS. 6A and 6B illustrate control of a room using four access network light fixtures, according to an example embodiment.

FIG. 7 illustrates a method executed by an access network light fixture, according to an example embodiment.

FIG. 8 illustrates a method executed by cloud services and/or light fixture control server, according to an example embodiment.

### DESCRIPTION OF EXAMPLE EMBODIMENTS

### OVERVIEW

In one embodiment, a method comprises transmitting, by an access network light fixture, scene information to a light fixture control server, the scene information being associated with a scene detected by one or more cameras associated with the access network light fixture, the scene being within a vicinity of the access network light fixture; receiving, by the access network light fixture, rendering information based on the scene information from the light fixture control server; and controlling, by the access network light fixture, projection of an image overlying the scene and projected by one or more image projectors associated with the access network light fixture based on the rendering information received from the light fixture control server.

In another embodiment, an apparatus comprises a network interface circuit, and a processor circuit. The network interface circuit can be configured to establish communications between an access network light fixture and a light fixture control server. The processor circuit can be configured to control transmission of scene information associated with a scene within a vicinity of the access network light fixture to the light fixture control server, reception of rendering information based on the scene information from the light fixture control server, and projection of an image overlying the scene and projected by one or more image projectors associated with the access network light fixture based on the rendering information received from the light fixture control server.

In another embodiment, logic is encoded in one or more non-transitory tangible media for execution by a machine, and when executed by the machine operable for: transmitting, by an access network light fixture, scene information to a light fixture control server, the scene information being associated with a scene detected by one or more cameras associated with the access network light fixture, the scene being within a vicinity of the access network light fixture; receiving, by the access network light fixture, rendering information based on the scene information from the light fixture control server; and controlling, by the access network light fixture, projection of an image overlying the scene and projected by one or more image projectors associated with the access network light fixture based on the rendering information received from the light fixture control server.

In another embodiment, a method comprises receiving, at a light fixture control server, scene information associated with a scene detected by one or more cameras within a vicinity of an access network light fixture; determining, at the light fixture control server, rendering information based on the scene information, the rendering information controlling projection of an image overlying the scene and projected by one or more image projectors associated with the access network light fixture; and transmitting, by the light fixture control server, the rendering information to the access network light fixture.

In another embodiment, an apparatus comprises a network interface circuit, and a processor circuit. The network interface circuit can be configured to establish communications between an access network light fixture and a light fixture control server. The processor circuit can be configured to control reception of scene information associated a scene detected by one or more cameras within a vicinity of an access network light fixture, determination of rendering information based on the scene information, and transmission of the rendering information to the access network light fixture, the rendering information controlling projection of an image overlying the scene and projected by one or more image projectors associated with the access network light fixture.

In another embodiment, logic is encoded in one or more non-transitory tangible media for execution by a machine, and when executed by the machine operable for: receiving, at a light fixture control server, scene information associated with a scene detected by one or more cameras within a vicinity of an access network light fixture; determining, at the light fixture control server, rendering information based on the scene information, the rendering information controlling projection of an image overlying the scene and projected by one or more image projectors associated with the access network light fixture; and transmitting, by the light fixture control server, the rendering information to the access network light fixture.

### DETAILED DESCRIPTION

Some LaaS installations can use smart bulbs that connect to IP networks with wireless links, and are retrofit into existing light fixtures and lamps. Other LaaS installations replace traditional light fixtures with Internet-enabled fixtures. Internet-enabled fixtures can receive electrical energy and network connectivity via Power over Ethernet (PoE) links. Applications executed on office networks, smart phones, etc. allow building occupants to set parameters for the operation of the smart bulbs. Parameters that may be controlled include brightness, on-off schedule, color, and control over the brightness in different parts of a room.

Particular embodiments enable a light fixture control server and/or cloud services to control an access network light fixture. The light fixture control server and/or cloud services can be configured to control fine granularity of a shape, color, brightness, etc. of radiation emitted by the access network light fixture. The light fixture control server and/or cloud services can be configured to control the access network light fixture in response to an analysis of a scene viewable within a vicinity of the access network light fixture. One or more ceiling mounted access network light fixtures can be configured and dynamically coordinated to create a seamless illumination field on all surfaces of a room.

The term “configured for” or “configured to” as used herein with respect to a specific operation refers to a device and/or machine that is physically constructed and arranged to perform the specified operation.

According to an example embodiment, the access network light fixture can be configured to use one or more cameras and one or more projectors. The one or more cameras can be configured to generate image data in response to detecting a scene within a vicinity of the access network light fixture. The access network light fixture can be configured to aggregate the image data from one or more cameras and generate scene information. The access network light fixture can be configured to transmit the scene information to the light fixture control server and/or cloud services.

The light fixture control server and/or cloud services can be configured to analyze the scene information (e.g., for shadows, glare on objects, seating areas, specific objects, gaze direction, target illumination levels and colors, etc.) and transmit rendering information to the access network light fixture to control illumination based on the scene information. The access network light fixture can be configured to use the rendering information as a basis for controlling the shape and brightness of radiation emitted by the access network light fixture. The “rendering information” can refer to image data and/or sound data (and/or metadata) that defines how one or more of the projectors should emit radiation with respect to shape, brightness, colors, etc. and/or how one or more speakers emit sound with respect to volume, bass, treble, etc. Special interactive features of the system can use the cameras, projectors, and video analytics to, e.g., create a virtual whiteboard, create interactive signs, create interactive video displays, eliminate objectionable glare produced by the projectors, remove effects of the shadows, eliminate glare on eyes, etc. and improve lighting and image quality. In some embodiments, the access network light fixture can be configured to implement security features, e.g., detecting motion for securing a room, and/or providing alarm displays and evacuation instructions in case of a building emergency.

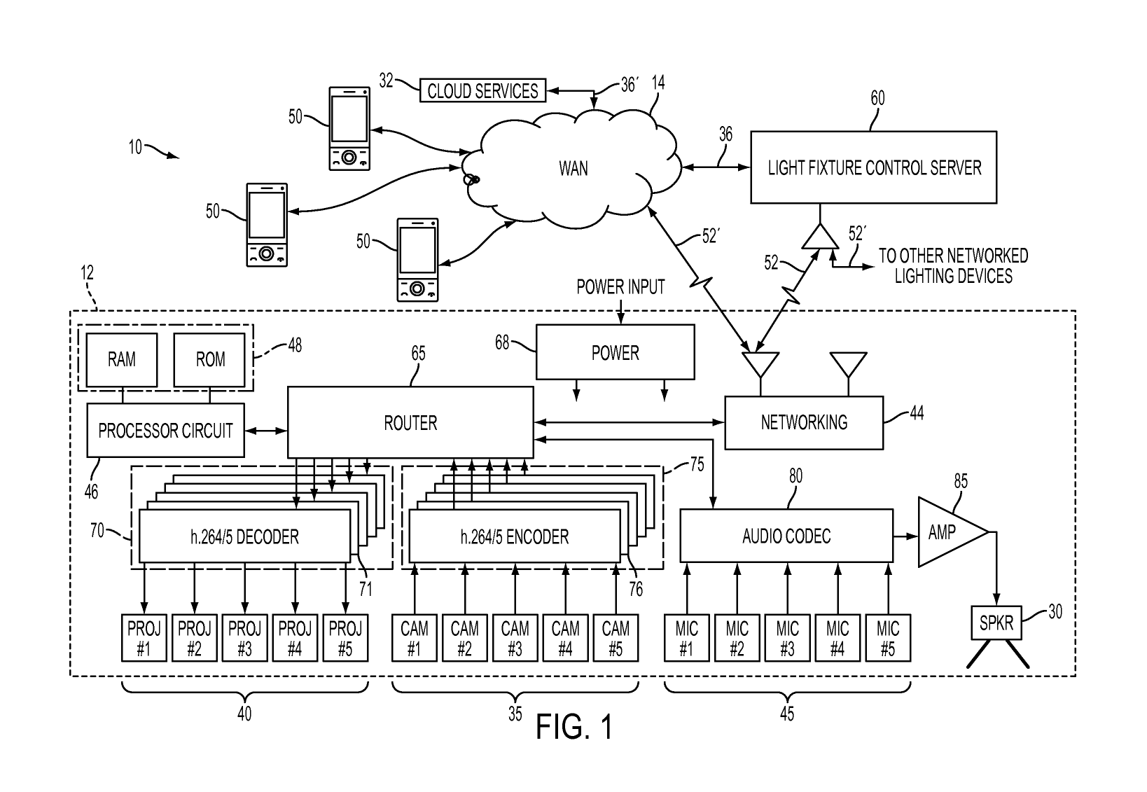

FIG. 1 illustrates a system 10 having an apparatus 12 configured to provide networked control over radiation emitted by the apparatus 12, according to an example embodiment. The apparatus 12 is a physical machine (i.e., a hardware device) configured for implementing network communications with other physical machines 32, 50, and/or 60 within the system 10. A single apparatus 12 is shown for simplicity as being in communication with cloud services 32 and/or a light fixture control server 60. The light fixture control server 60 and/or cloud services 32 can be configured to communicate with any number of apparatus 12 that are needed to illuminate a given space. In some embodiments, the light fixture control server 60 can be positioned near the apparatus 12, e.g., in a closet or server room.

The system 10 can comprise smart devices 50, cloud services 32, a Wide Area Network (“WAN”) 14, a light fixture control server 60, and the apparatus 12, implemented as an access network light fixture 12. The access network light fixture 12 can comprise memory circuits 48, a processor circuit 46, a router 65, a power circuit 68, a network interface circuit 44, a decoder block 70, an encoder block 75, an audio Coder/Decoder (“CoDec”) 80, an amplifier 85, a speaker 30, one or more projectors 40, one or more cameras 35, and one or more microphones 45. In some embodiments, the access network light fixture 12 can be affixed to a ceiling mounted light fixture, and can replace a standard light bulb. In some embodiments, the access network light fixture 12 can be configured to detachably connect to one or more projectors 40, one or more cameras 35, one or more speakers 30, and/or one or more microphones 45 to the mechanical housing of the access network light fixture 12.

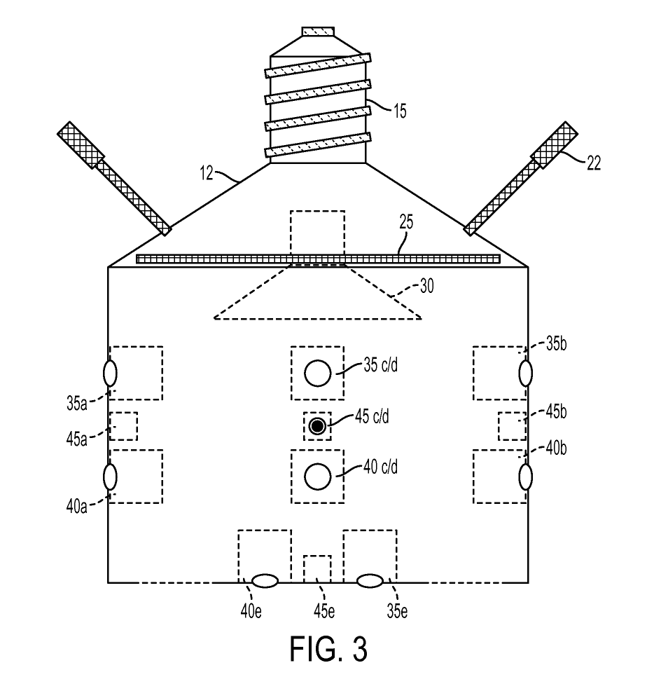

The power circuit 68 can be configured to convert input power supplied to the access network light fixture 12, e.g., building AC power, Power over Ethernet (PoE) power, battery power, etc., into one or more internal voltages. The power circuit 68 can be configured to supply the one or more internal voltages to one or more internal power buses (not shown). The access network light fixture 12 can be configured to be supplied power by a standard Edison lamp base 15 (shown in FIG. 3) or other light base depending upon country and lamp type.

The network interface circuit 44 can be configured to provide a link layer data connection 52. The link layer data connection 52 can connect the access network light fixture 12 to smart devices 50, the light fixture control server 60 and/or cloud services 32. The light fixture control server 60 can be configured to include a WAN connection 36 to reach cloud services 32 via the WAN 14 (e.g., the Internet). The link layer data connections 36 and 52 can be implemented using, e.g., Ethernet, PoE, Wi-Fi, Fiber optic, HomePlug, high speed Ethernet, etc.

The router 65 can be configured to route internal Internet Protocol (IP) packets to their appropriate destinations. The router 65 can be configured to route IP packets received by the access network light fixture 12 to the decoder block 70 and the CoDec 80. The router 65 can be configured to route IP packets from an encoder block 75 and/or CoDec 80 to the network interface circuit 44. The processor circuit 46 can be configured to control the functions performed by the router 65, e.g., maintaining a router table, performing table look-ups, etc. The processor circuit 46 in conjunction with memory circuits 48, e.g., a RAM and/or ROM, can execute control operations performed with the access network light fixture 12. In some embodiments, the access network light fixture 12 can be comprised of one or more microphones 45, e.g., five microphones 45. The five microphones 45 (e.g., directional microphones) can detect and at least partially localize sounds within the vicinity of the access network light fixture 12.

The audio CoDec 80 can be configured to encode audio signals captured by the microphones 45 for transmission to the light fixture control server 60 and/or cloud services 32. The audio CoDec 80 can be configured to decode audio signals received from light fixture control server 60 and/or cloud services 32 and output analog audio signals to the amplifier 85. The amplifier 85 can be configured to amplify the analog signal received from the audio CoDec 80 and drive the speaker 30.

The speaker 30 can be configured to emit audio information generated by the light fixture control server 60, cloud services 32, and/or the smart devices 50. The speaker 30 can be used to produce audible feedback, sounds for applications, such as collaboration/telepresence, room-level public address (PA), emergency alarms, etc.

The one or more cameras 35, e.g., five cameras 35, and one or more microphones 45 can be “associated with” the access network light fixture 12 in that the access network light fixture 12 can use the one or more cameras 35 and the one or more microphones 45 to capture a scene within a vicinity of the access network light fixture 12. Scene information can be “associated with” the scene (e.g., person(s), furniture, color of object(s), eye gaze direction, movements, sound, etc.) within a room in that the scene can be a collection of one or more images detected by one or more cameras 35 and represented by image data and/or sound as detected by one or more microphones 45 and represented by sound data. The access network light fixture 12 can be configured to aggregate the image data and/or sound data to form the scene information.

The five cameras 35 can be configured to connect to an encoder block 75 comprised of one or more encoders 76, e.g., five encoders 76. The encoders 76 can be configured to use, e.g., h.264 or h.265 video compression standard, to greatly reduce network bandwidth needed to send image data generated by the cameras 35 to the light fixture control server 60 and/or cloud services 32.

The access network light fixture 12 can be configured to send data to one or more of the projectors 40. The projectors 40 can produce high brightness HDTV-class resolutions, with aggregate light flux output similar to a standard light bulb. The projectors 40 can be configured to project individually selected images displayed in full color. High brightness, high resolution images can be used to create virtual artwork on walls, virtual carpet on floors, and turn all surfaces in a room into interactive digital signs and video displays. The projectors 40 can be configured to have individually controllable pixels, allowing for different patterns of illumination and brightness to be achieved on all surfaces within reach of the access network light fixture 12. The access network light fixture 12 can be configured to control illumination and brightness by loading calculated images into any or all of the five decoders 71. The calculated images can be set up manually with a smart device 50 to control the individual brightness on different subsets of pixels on individual projectors 40.

The five projectors 40 can be configured to connect to a decoder block 70 comprised of one or more decoders 71, e.g., five decoders 71. The decoders 71 can be configured to use either the h.264 or h.265 video compression standard to greatly reduce network bandwidth needed to drive the projectors 40 with still and moving images.

The five projectors 40 can be configured to project overlapping directional imaging patterns in four cardinal directions and below the access network light fixture 12. The access network light fixture 12 can be configured to project an image anywhere in a room that is within a line of sight of the access network light fixture 12. The projectors 40 can be configured to project images using any of a variety of technologies that allow projections anywhere in a room, e.g., several hundred high power LED chips and optics, high brightness miniature video projectors, laser based devices, etc.

In an example embodiment, a single access network light fixture 12 can be mounted at a center of a ceiling of a modest sized room, e.g., a bedroom, office, or conference room, that can be approximately 16 feet×16 feet (5 meters×5 meters) or smaller in dimension. The five projectors 40 can be configured to create beams of light that illuminate four walls of a room and floor, and any objects within the room (e.g., furniture, people in the room, artwork).

The network interface circuit 44 can be configured to provide data communications between the access network light fixture 12 and the light fixture control server 60 and/or cloud services 32 and/or smart devices 50.

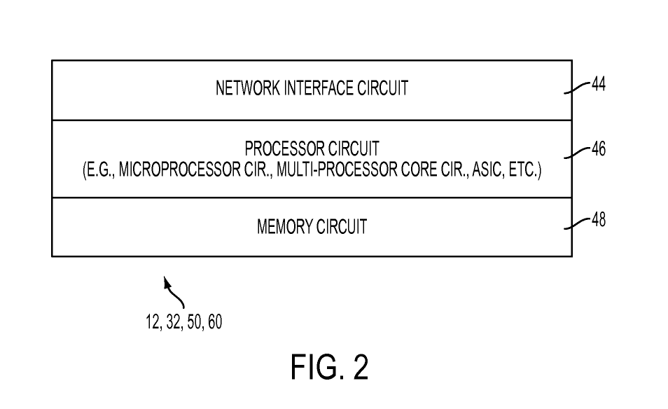

FIG. 2 illustrates an example implementation of any one of the apparatus 12, 32, 50, and/or 60 of FIG. 1, according to an example embodiment.

Each apparatus 12, 32, 50, and/or 60 can include a network interface circuit 44, a processor circuit 46, and a memory circuit 48. The network interface circuit 44 can include one or more distinct physical layer transceivers for communication with any one of the other devices 12, 32, 50, and/or 60 according to the appropriate physical layer protocol (e.g., Wi-Fi, DSL, DOCSIS, 3G/4G, Ethernet, etc.) via any of the links 36, 36′, 52, 52′ (e.g., a wired or wireless link, an optical link, etc.), as appropriate.

The processor circuit 46 can be configured for executing any of the operations described herein and control any and/or all of the components within the apparatus 12, and the memory circuit 48 can be configured for storing any data or data packets as described herein.

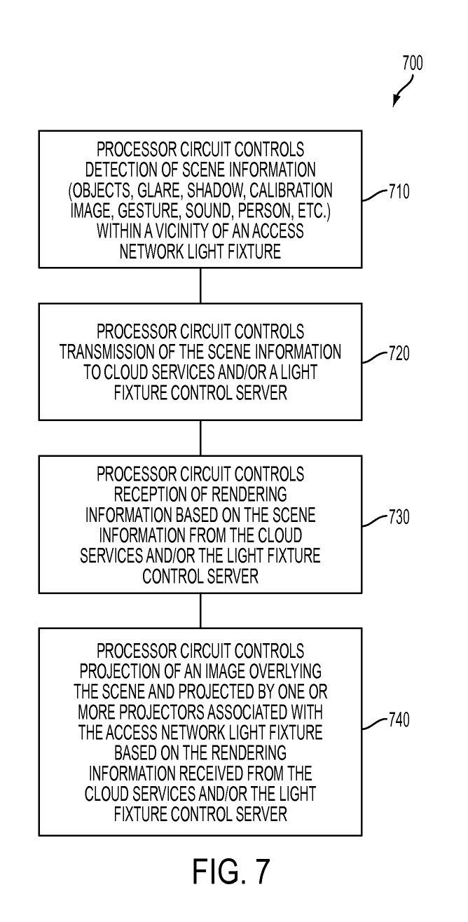

FIG. 7 illustrates a method 700 executed by an access network light fixture, according to an example embodiment. As described in combination with respect to FIGS. 1 and 2, the access network light fixture 12 (executed for example by processor circuit 46 of FIG. 2 and/or a logic circuit) can implement a method 700 to capture scene information within a vicinity of the access network light fixture 12 and control one or more projectors 40, according to example embodiments.

Referring to operation 710, the processor circuit 46 of the access network light fixture 12 can be configured to control detection of scene information (e.g., calibration image, objects, glare, shadow, gesture, person, and/or sound, etc.) within a vicinity of the access network light fixture 12. The processor circuit 46 can be configured to control reception of image data and/or sound data respectively from one or more cameras 35 and/or one or more microphones 45 of one or more access network light fixtures 12.

The processor circuit 46 of the access network light fixture 12, in operation 720, can be configured to control transmission of the scene information to the light fixture control server 60 and/or cloud services 32.

In operation 730, the processor circuit 46 of the access network light fixture 12 can be configured to receive rendering information comprising one or more data packets that is based on the scene information transmitted in operation 720. The rendering information can be received from the light fixture control server 60 and/or cloud services 32.

In operation 740, the processor circuit 46 of the access network light fixture 12 can be configured to control projection of an image by one or more projectors 40 based on the rendering information received in operation 730. The rendering information (e.g., video, still image, lighting, a correction to compensate for color inaccuracies, a correction to compensate for one or more shadows, a correction to compensate for glare, sound, etc.) can instruct the access network light fixture 12 to individually activate one or more projectors 40 and individually activate one or more pixels within each of the one or more projectors 40 at a specified brightness and/or color. The rendering information can instruct the access network light fixture 12 to activate the speaker 30 to produce sound.

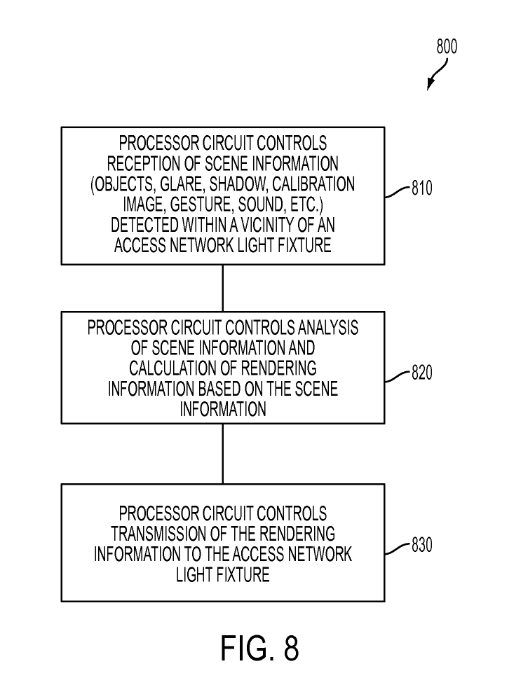

FIG. 8 illustrates a method executed by cloud services and/or light fixture control server, according to an example embodiment. As described in combination with respect to FIGS. 1 and 2, the light fixture control server 60 and/or cloud services 32 (executed for example by processor circuit 46 of FIG. 2 and/or a logic circuit) can implement a method 800 to determine rendering information based on the scene information received from the access network light fixture 12, according to example embodiments.

The processor circuit 46 of the light fixture control server 60 and/or cloud services 32 can be configured to receive in operation 810 the scene information having been transmitted by the access network light fixture 12 in operation 720, as discussed above.

The light fixture control server 60 and/or cloud services 32 can be configured to automatically calculate rendering information based on the scene information. As discussed above, the cameras 35 can be configured to capture images in one or more viewable directions within a vicinity of the access network light fixture 12 and the microphones 45 can be configured to capture a sound in one or more directions within a vicinity of the access network light fixture 12. The processor circuit 46 of the light fixture control server 60 and/or cloud services 32 in operation 820 can be configured to analyze the scene information produced by one or more access network light fixtures 12 (e.g., images produced by the cameras 35 and/or sound detected by the microphones 45) received in operation 810. The light fixture control server 60 and/or cloud services 32 can be configured to calculate rendering information that is based on the scene information. The light fixture control server 60 and/or cloud services 32 can be configured to control a lighting plan for the room based on the scene information.

The processor circuit 46 of the light fixture control server 60 and/or cloud services 32 in operation 820 can be configured to analyze images captured by the cameras 35 as a basis to calculate calibration data. The light fixture control server 60 and/or cloud services 32 can be configured to calculate calibration data to ensure geometry alignment of projected images produced by of any two projectors 40 of one or more access network light fixtures 12 that project overlying images onto a same area of a scene. Calibration data can maintain illumination levels, assure images are reaching surfaces as dictated by rendering information, assure pixels overlap in regions where an image is created by two or more overlying projectors 40, correct for distortions, and adjust image projection until a seamless illumination field is obtained on all surfaces that can be illuminated by the system 10.

The processor circuit 46 of the light fixture control server 60 and/or cloud services 32 in operation 820 can be configured to analyze images captured by the cameras 35 as a basis to determine that specific objects exist with a room scene that require localized lighting adjustments. For example, the light fixture control server 60 and/or cloud services 32 can be configured to analyze an image generated by the cameras 35 and determine that a video screen (e.g., moving images, rectangular area) exists within a room scene. The light fixture control server 60 and/or cloud services 32 can be configured to calculate rendering information in response to the determination that the video screen exists within the room. The light fixture control server 60 and/or cloud services 32 can be configured to send the rendering information to the access network light fixture 12. The rendering information can instruct one or more appropriate projectors 40 that project on the video screen to dim pixels the access network light fixture 12 projects onto the video screen to improve contrast and minimize glare while viewing the video screen. In some embodiments, the system 10 can be configured to block light from illuminating sensitive areas, e.g., parts of a room where people may be sleeping, etc., while providing adequate illumination levels to a rest of a room.

The processor circuit 46 of the light fixture control server 60 and/or cloud services 32 in operation 820 can be configured to analyze images captured by the cameras 35 as a basis to brighten specific objects, e.g., a desktop, that are determined to exist within a room scene and calculate rendering information for the specific objects. For example, the light fixture control server 60 and/or cloud services 32 can be configured to send rendering information instructing one or more appropriate projectors 40 that project on the desktop to brighten pixels the access network light fixture 12 projects onto the desktop. The light fixture control server 60 and/or cloud services 32 can be configured to control light for, e.g., a user reading printed material, a user using a computing device, highlighting merchandise in a retail setting (e.g., jewelry), illuminating medical or dental procedures, providing additional light on stairways, providing additional light on artwork, seating areas, etc.

The processor circuit 46 of the light fixture control server 60 and/or cloud services 32 in operation 820 can be configured to analyze images captured by the cameras 35 as a basis to control color correction. Depending upon the shape of the room 55 and/or the objects within the room 55, the color of the room 55 and/or the objects can become inconsistently lighted and/or inaccurately colored due to reflections, lighting variations, etc. The light fixture control server 60 and/or cloud services 32 can be configured to analyze a scene of a room at various lighting levels to detect inconsistent and/or inaccurate color within the room 55. The light fixture control server 60 and/or cloud services 32 can be configured to calculate rendering information to control localized lighting at an area to correct for the lighting inconsistency and/or color inaccuracies.

The processor circuit 46 of the light fixture control server 60 and/or cloud services 32 in operation 820 can be configured to enable control modes for the access network light fixtures 12. The microphone 45 can be configured to capture a sound (e.g., a voice command) within a vicinity of the access network light fixture 12. The access network light fixture 12 can generate sound information that is “associated with” the sound captured by the microphone 45 in that the sound can be represented by sound data. The access network light fixture 12 can be configured to convert an analog signal generated by the microphone 45 into the sound data. The access network light fixture 12 can be configured to aggregated sound data to generate the sound information associated with the sound captured by a microphone 45 and transmit scene information comprising the sound information to the light fixture control server 60 and/or cloud services 32. The light fixture control server 60 and/or cloud services 32 can be configured to implement speech recognition control processes on the sound information to determine that the sound information represents, e.g., a spoken voice command. The light fixture control server 60 can be configured to receive sound information from a plurality of access network light fixtures 12 to improve sound quality of the received sound information, localize the sound information, and improve accuracy of the speech recognition. The light fixture control server 60 and/or cloud services 32 can be configured to calculate rendering information based on the voice command. For example, the access network light fixture 12 can be configured to detect a sound of a person saying a voice command such as “lights dim fifty percent”, and have the voice command acted upon by the light fixture control server 60 and/or cloud services 32 to dim projectors 40 to half of their current brightness.

The processor circuit 46 of the light fixture control server 60 and/or cloud services 32 in operation 820 can be configured to enable gesture commands made by a person. Control gesture information associated with the control gesture can be transmitted to the light fixture control server 60 and/or cloud services 32. The light fixture control server 60 and/or cloud services 32 can be configured to implement gesture recognition control processes on the control gesture information to determine that a gesture command was desired by the person. The light fixture control server 60 and/or cloud services 32 can be configured to calculate rendering information based on the gesture command. For example, a person can, e.g., make a thumbs-up gesture and outline an area with his index finger. A projector 40 associated with the outlined area can be brightened by the light fixture control server 60 and/or cloud services 32 to provide higher lighting levels by the access network light fixture 12.

The processor circuit 46 of the light fixture control server 60 and/or cloud services 32 in operation 820 can be configured to provide user control of a network light fixture 12. The light fixture control server 60 can be configured to connect to cloud services 32 over the WAN 14. The smart devices 50 (e.g., smart phones, PCs, tablet computers, etc.) can be configured to comprise a user interface to send control data to the light fixture control server 60 and/or cloud services 32. The control data can instruct the light fixture control server 60 and/or cloud services 32 to calculate rendering information to control emissions produced by the access network light fixture 12. In some embodiments, the processor circuit 46 of the smart device 50 can be configured to directly transmit, without going through the light fixture control server 60 and/or cloud services 32, in operation 830 the rendering information to the access network light fixture 12.

The processor circuit 46 of the light fixture control server 60 and/or cloud services 32 in operation 820 can be configured to adjust a location of a projection of an image projected by the projectors 40 to assure a same image projected by a plurality of projectors 40 overlaps and properly aligns. The light fixture control server 60 and/or cloud services 32 can be configured to send test pattern rendering information to a plurality of projectors 40 that project overlapping images. The cameras 30 can be configured to capture the test patterns. The access network light fixture 12 can be configured to send the test pattern information associated with the test patterns to the light fixture control server 60 and/or cloud services 32. The light fixture control server 60 and/or cloud services 32 can be configured to analyze the test pattern information associated with the captured test patterns, and calculate calibration information. The light fixture control server 60, the cloud services 32 and/or the access network light fixture 12 can be configured to adjust the rendering information with the calibration information to adjust a location of a projection of an image projected by the projectors 40. The calibration information can be stored in memory circuit 48 (e.g., RAM, ROM), or in the light fixture control server 60, or cloud services 32.

In some embodiments, the processor circuit 46 of the light fixture control server 60 and/or cloud services 32 in operation 820 can be configured to adjust actuators. The access network light fixture 12 can be comprised of actuators that adjust projection directions of the projectors 40 in response to the calibration information. The light fixture control server 60 and/or cloud services 32 can be configured to calculate rendering information that is comprised of actuator adjustment commands. The actuator adjustment commands can be configured to instruct the access network light fixture 12 to move the actuators individually controlling a projection direction, focus and zoom of each of the projectors 40.

In some embodiments, the processor circuit 46 of the light fixture control server 60 and/or cloud services 32 in operation 820 can be configured to continuously monitor in real-time image overlap during image projection. The light fixture control server 60 and/or cloud services 32 can continuously monitor camera 35 images and continuously calculate rendering information that corrects for images that do not overlap. Continuous monitoring and continuous correction of rendering information can provide a continuous feedback loop to allow the light fixture control server 60 and/or cloud services 32 to continuously adjust the projection of images to maintain image overlap. Continuous monitoring can be used in applications where the cameras 35 and projectors 40 are subject to vibration and/or movement, such as on a boat, train, amusement park ride, etc., and/or where objects in a room may move during a session, such as a movable partition wall or folding table.

The processor circuit 46 of the light fixture control server 60 and/or cloud services 32 can be configured to transmit in operation 830 rendering information calculated in operation 820 to the access network light fixture 12. The light fixture control server 60 and/or cloud services 32 can be configured to transmit the calculated rendering information to one or more access network light fixture(s) 12 for projection of an image by one or more projectors 40 onto a calculated specific location within a room scene.

FIG. 3 illustrates in further detail the apparatus of FIG. 1, according to an example embodiment. In particular, FIG. 3 illustrates a side view of a mechanical housing of an access network light fixture 12, according to an example embodiment.

The access network light fixture 12 is illustrated as being comprised of five projectors 40a-e, five cameras 35a-e, a speaker 30, five microphones 45a-e, and a printed circuit board 25. The printed circuit board 25 can be located, e.g., at the top of the mechanical housing, and be comprised of electronic circuitry (e.g., 25, 44, 46, 48, 65 68, 70, 75, 80, 85) that operate the access network light fixture 12.

Four of the projectors 40a-d can be positioned to project horizontally in four cardinal directions. The fifth projector 40e can positioned to project in a downward direction. The projectors 40 can be configured to project a far-field image on walls, floor, and furnishings of a room, and provide for general illumination, imaging and interactive services. A field of view of the projectors 40 can be set by the optics of the projectors 40 to overlap, e.g., using approximately 100 degrees as a divergence angle.

Four of the cameras 35a-e can be positioned to capture images horizontally in four cardinal directions. The fifth camera 35d can be positioned to capture images in a downward direction. A field of view of the cameras 35 can be set by the optics of the cameras 35 to overlap, e.g., using approximately 100 degrees as a divergence angle.

The four directional microphones 45a-d can be positioned to capture sounds in four cardinal directions. The fifth microphone 45e can be positioned to capture sounds below the access network light fixture 12. In some embodiments, pickup patterns of microphones 45 can be unidirectional.

The speaker 30 can be centrally located at the top of a housing of the access network light fixture 12, as illustrated.

The network interface circuit 44 can be comprised of one or more Wi-Fi antennas 22 and associated RF electronic circuitry.

In some embodiments, the access network light fixture 12 can be a cylinder that is approximately 4 inches/10 cm in diameter and 4 inches/10 cm tall. A light fixture extension can be used with the access network light fixture 12 for deeply recessed fixture mounts. The light fixture extension can allow the access network light fixture 12 to extend beyond an obstruction created by a ceiling light fixture recess.

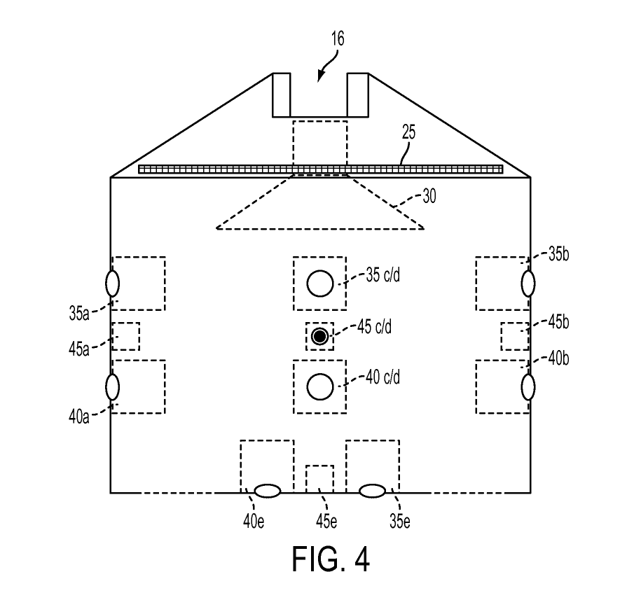

FIG. 4 illustrates in further detail the apparatus of FIG. 1, according to an alternative example embodiment. In particular, FIG. 4 illustrates a side view of a mechanical housing diagram of an access network light fixture 12, according to another example embodiment.

The access network light fixture 12 of FIG. 4 eliminates the Wi-Fi antennas 22 and Edison lamp base 15 shown in FIG. 3. The access network light fixture 12 of FIG. 4 can be configured to include a Power over Ethernet (PoE) connector 16. The PoE connector 16 can be configured to provide both power and network connectivity. In some embodiments, the access network light fixture 12 that includes a PoE connector 16 can be mounted to a mounting plate or a clip that attaches to tracks in a suspended ceiling.

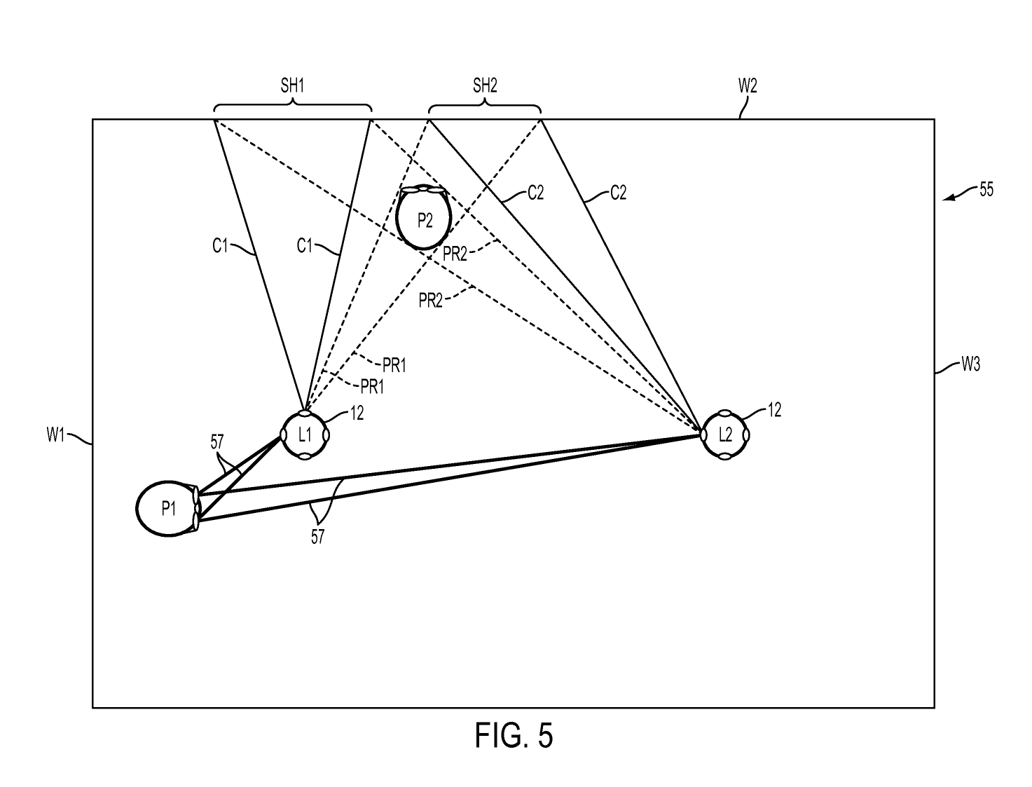

FIG. 5 illustrates control of two access network light fixtures 12, according to an example embodiment. In the example embodiment shown in FIG. 5, a top view of two access network light fixtures L1 and L2 12 are shown as concurrently projecting overlapping images overlying a scene in a room 55, e.g., a conference room. The ten projectors 40 contained in access network light fixtures L1 and L2 12 can be configured to illuminate all walls and floors with overlapping beams. The majority of positions on the walls and floors of the room 10 can be illuminated by at least two projectors 40.

A top of a head of a person P1 is depicted as looking to the right side of the room 55 toward a wall W3. The person P1 looking to the right side of the room 55 may be uncomfortable or be put in a dangerous situation when looking toward left-shining projectors of access network light fixtures L1 and L2 12 that are projecting at a high brightness toward the person P1. The cameras 35 in one or more of access network light fixtures L1 and L2 12 can be configured to capture an image of the room scene that is comprised of the person P1 looking toward the left-shining projectors of access network light fixtures L1 and L2 12. The processor circuit 46 of the access network light fixtures L1 and L2 12, in operation 720, can be configured to control transmission of the scene information comprising the captured image of the person P1 looking toward the left-shining projectors 40 of access network light fixtures L1 and L2 12 to the light fixture control server 60 and/or cloud services 32.

The processor circuit 46 of the light fixture control server 60 and/or cloud services 32 in operation 820 can be configured to use analytics control processes to analyze the scene information and recognize a location and/or direction of view of an eye of person P1, and any other person(s) that are within the room. The light fixture control server 60 and/or cloud services 32 can be configured to determine which two (or more) projectors 40 will produce light that will intercept the eyes of person P1, i.e., glare. The light fixture control server 60 and/or cloud services 32 can be configured to calculate rendering information that controls projection for projectors 40 that reduces brightness on those pixels calculated to project on the eyes of person P1. This reduced brightness can eliminate glare on the eyes of person P1. The reduced brightness pixels are shown as beam paths 57.

In some embodiments, as person P1 moves about the room 55, or changes gaze angles, the cameras 35 can be configured to continuously capture the movement and gaze angle changes of person P1. The processor circuit 46 of the access network light fixtures L1 and L2 12, in operation 720, can be configured to control transmission of the scene information to the light fixture control server 60 and/or cloud services 32. The processor circuit 46 of the light fixture control server 60 and/or cloud services 32 in operation 820 can be configured to continuously analyze the scene information and recognize a location of the eyes of person P1.

The light fixture control server 60 and/or cloud services 32 can be configured in operation 720 responsive to the scene information updates, to continuously output successive scene information updates that update eye positions of person P1. The light fixture control server 60 and/or cloud services 32 can be configured in operation 820 to continuously update rendering information in operation 720 responsive to the scene information updates and transmit in operation 830 the updated rendering information in real-time to track the eyes of the person P1. The continuous updates of the rendering information by the light fixture control server 60 and/or cloud services 32 can provide continuous glare elimination while the person P1 moves about the room 55. The access network light fixture 12 can be configured to simultaneously provide floor-to-ceiling projection of images and/or video on all walls of the room 55 while simultaneously preventing objectionable glare when persons P1 and P2 face one(or more) of the projectors 40.

Person P2 is illustrated as facing away from the projectors 40 and facing wall W2, e.g. writing on a whiteboard. A light path of an image PR1 from access network light fixture L1 12 is shown as hitting the back of the head of person P2 and can result in shadow region SH2 being produced. A light path of an image PR2 from access network light fixture L2 12 is shown as hitting the back of the head of person P2 and can result in shadow region SH1 being produced. If the projectors 40 of access network light fixtures L1 12 and L2 12 are projecting an image on the wall W2 of a room 55 in front of person P2, e.g., supporting an interactive virtual whiteboard application, shadows can greatly deteriorate the image quality viewed by person P2 and others in the room 55.

The processor circuit 46 of the light fixture control server 60 and/or cloud services 32 can be configured to control reception, in operation 710, of images captured with cameras 35 that include the shadow regions SH1, SH2 created by person P2. The processor circuit 46 of the light fixture control server 60 and/or cloud services 32 in operation 820 can be configured to analyze video data to determine that a shadow region SH1 and/or SH2 is caused by person P2 obscuring the image projected on wall W2. The processor circuit 46 of the light fixture control server 60 and/or cloud services 32 in operation 820 can be configured to calculate rendering information comprising a compensation image C1 to compensate for shadow region SH1 and a compensation image C2 to compensate for shadow region SH2. The rendering information can instruct access network light fixture L1 12 to project compensating image C1, e.g., at approximately twice a nominal brightness for regions not in shadow, to illuminate pixels projecting onto the shadow region SH1. The rendering information can instruct access network light fixture L2 12 to project compensating image C2, e.g., at approximately twice brightness, to illuminate pixels projecting onto the shadow region SH2. Compensation images C1 and C2 can restore a rear-projection quality to the image in the presence of front-projection shadows. In some embodiment, shadow compensate can be performed dynamically in real-time as persons P1 and P2 move about the room 55.

The processor circuit 46 of the light fixture control server 60 and/or cloud services 32 can be configured to transmit in operation 830 rendering information comprising compensating images C1 and C2 calculated in operation 820 to the access network light fixture 12. In operation 740, the processor circuit 46 of the access network light fixture 12 can be configured to control projection of an image based on the rendering information comprising compensating images C1 and C2 received in operation 720.

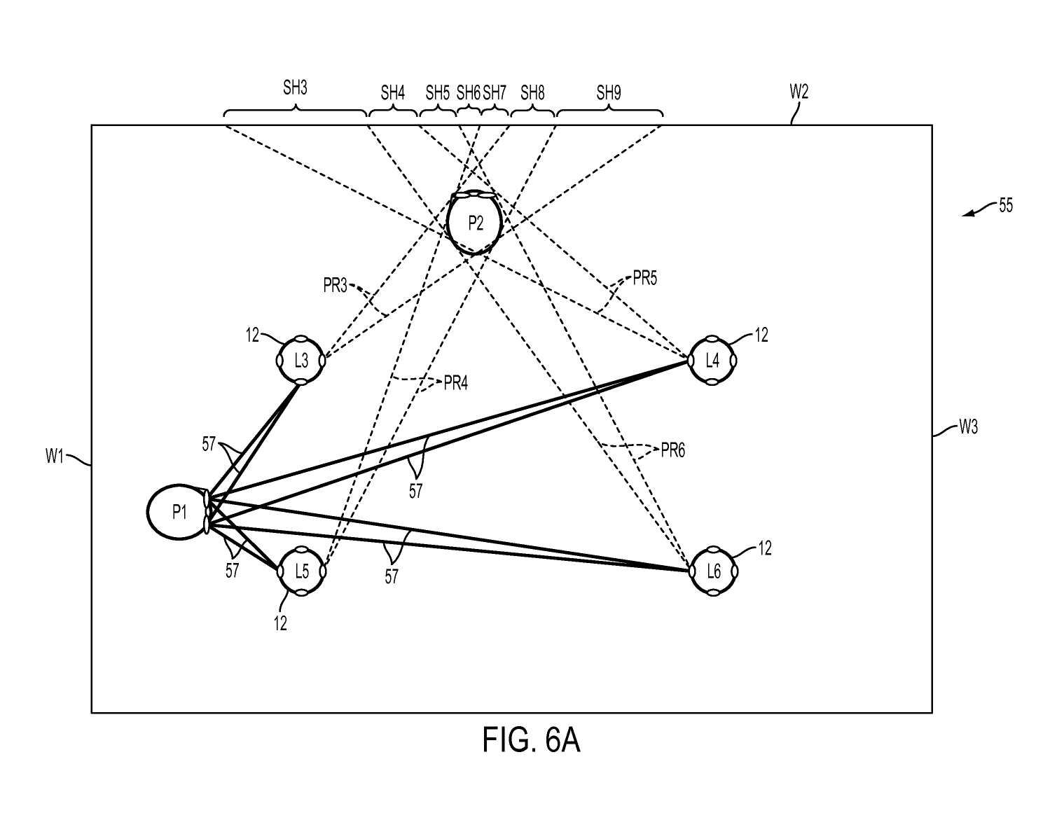

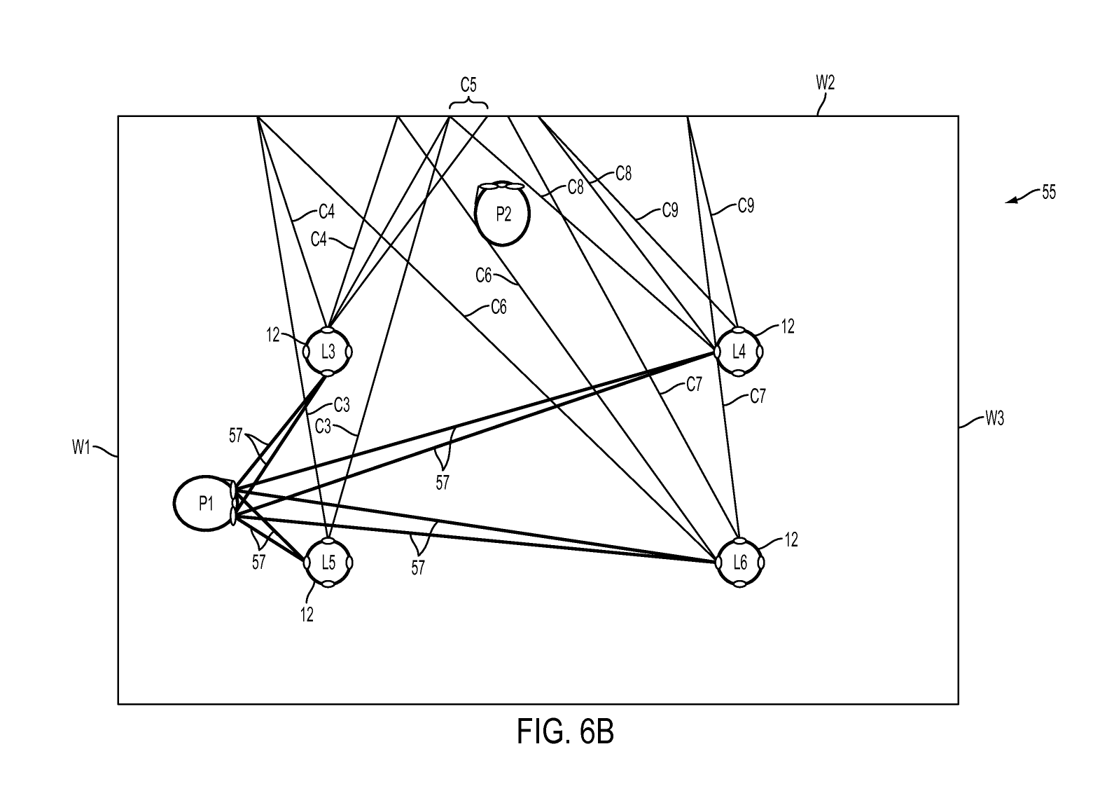

FIGS. 6A and 6B illustrate control of a room 55 using four access network light fixtures L3-L6 12, according to an example embodiment. In some embodiments, the four access network light fixtures L3-L6 12 can be configured to use twenty high definition cameras 35 that can measure forty million individual, overlapping sense points. The four access network light fixtures L3-L6 12 can be configured to use twenty high definition projectors 40 that can project still or moving images containing 40 million overlapping pixels projected into the room 55.

As shown in FIGS. 6A and 6B, four (or more) access network light fixtures L3-L6 12 can be configured in a rectangular grid pattern to minimize dead spots. Use of the four (or more) access network light fixtures L3-L6 12 can provide coverage of over 95% of the room 55 to provide shadow compensation.

FIG. 6A illustrates a top of a head of a person P1 as looking to the right side of the room 55 toward a wall W3. The person P1 looking to the right side of the room 55 may be uncomfortable or be put in a dangerous situation when looking toward left-shining projectors 40 of access network light fixtures L3-L6 12 that are projecting at a high brightness toward the person P1. The cameras 35 in one or more of access network light fixtures L3-L6 12 can be configured to capture an image of the room 55 scene that is comprised of the person P1 looking toward the left-shining projectors of access network light fixtures L3-L6 12.

The processor circuit 46 of the access network light fixtures L1 and L2 12, in operation 720, can be configured to control transmission of the scene information comprising the captured image of the person P1 looking toward the left-shining projectors 40 of access network light fixtures L3-L6 12 to the light fixture control server 60 and/or cloud services 32.

The processor circuit 46 of the light fixture control server 60 and/or cloud services 32 in operation 820 can be configured to use analytics control processes to analyze the scene information and recognize a location and/or direction of view of an eye of person P1. The light fixture control server 60 and/or cloud services 32 can be configured to determine which four projectors 40 will produce light that will intercept the eyes of person P1. The light fixture control server 60 and/or cloud services 32 can be configured to calculate rendering information in operation 820 that controls projection for projectors 40 that reduces brightness on those pixels calculated to project on the eyes of person P1. This reduced brightness can eliminate glare on the eyes of person P1. The reduced brightness pixels are shown as beam paths 57. The processor circuit 46 of the light fixture control server 60 and/or cloud services 32 can be configured to transmit in operation 830 the rendering information comprising the reduced brightness on those pixels calculated to project on the eyes of person P1.

As illustrated in FIG. 6A, person P2 is illustrated as facing away from the projectors 40 facing wall W2. The four access network light fixtures L3-L6 12 can cast shadows in shadow regions SH3-SH9 due to person P2 standing along wall W2. Access network light figure L3 12 is illustrated as projecting an image PR3 toward wall W2, with person P2 obstructing projected image PR3 and thus causing a shadow in shadow regions SH8 and SH9. Access network light figure L5 12 is illustrated as projecting an image PR4 toward wall W2, with person P2 obstructing projected image PR4 and thus causing a shadow in shadow regions SH7 and SH8. Access network light figure L4 12 is illustrated as projecting an image PR5 toward wall W2, with person P2 obstructing projected image PR5 and thus causing a shadow in shadow regions SH3 and SH4. Access network light figure L6 12 is illustrated as projecting an image PR6 toward wall W2, with person P2 obstructing projected image PR6 and thus causing a shadow in shadow regions SH4 and SH5.

The shadow regions SH3-SH9 can vary in brightness as a result of overlapping projections produced by access network light fixtures L3-L6 12. The processor circuit 46 of one or more of the access network light fixtures L3-L6 12, in operation 720, can be configured to control transmission of the scene information comprising the captured image of the person P2 standing along wall W2 and casting shadows in shadow regions SH3-SH9 to the light fixture control server 60 and/or cloud services 32.

FIG. 6B illustrates access network light fixtures L3-L6 12 projecting compensating images C3-C9 to compensate for the shadow regions SH3-SH9 illustrated in FIG. 6A. The processor circuit 46 of the light fixture control server 60 and/or cloud services 32 can be configured to control reception, in operation 810, of images captured with cameras 35 that include the shadow regions SH3-SH9 of FIG. 6A created by person P2. The processor circuit 46 of the light fixture control server 60 and/or cloud services 32 in operation 820 can be configured to analyze image data to determine that the shadow region SH3-SH9 of person P2 is obscuring the image projected on wall W2. The processor circuit 46 of the light fixture control server 60 and/or cloud services 32 in operation 820 can calculate rendering information comprising compensation images C3-C9 to compensate for shadow regions SH3-SH9. The rendering information can instruct projectors 40 to illuminate pixels projecting onto the shadow regions SH3-SH9 to be illuminated by the aligned, overlapping image from an opposite projector 40 at a higher brightness. Compensation images C3-C9 can restore a rear-projection quality to the image in the presence of front-projection shadows. The light fixture control server 60 and/or cloud services 32 in operation 820 can use ray tracing, physical 3D modeling of objects and people in the room 55, and illumination models to aid in the calculation of compensating images C3-C9.

The rendering information can instruct access network light fixture L3 12 to project compensating image C4 and C5 to illuminate pixels projecting onto respective shadow regions SH3 and SH5. The rendering information can instruct access network light fixture L4 12 to project compensating images C8 and C9 to illuminate pixels projecting onto respective shadow regions SH5-SH7 and shadow regions SH8 and SH9. The rendering information can instruct access network light fixture L5 12 to project compensating images C3 to illuminate pixels projecting onto shadow regions SH3 and SH4. The rendering information can instruct access network light fixture L6 12 to project compensating images C6 and C7 to illuminate pixels projecting onto respective shadow region SH3 and shadow regions SH7-SH9.

The processor circuit 46 of the light fixture control server 60 and/or cloud services 32 can be configured to transmit in operation 830 rendering information comprising compensating images C3-C9 calculated in operation 820 to the access network light fixture 12.

In operation 740, the processor circuit 46 of the access network light fixture 12 can be configured to control projection of an image based on the rendering information comprising compensating images C3-C9.

In some embodiments, specific objects of interest could be tracked throughout a three-dimensional (“3D”) space, and the system 10 can be configured to illuminate objects within the 3D space with brighter light, a distinctive color, or a blink pattern as they move and their motions are recorded in the light fixture control server 60 and/or cloud services 32. Illuminating objects in the 3D space can be used, e.g., to track or secure valuable, sensitive, or hazardous objects throughout the 3D space, in retail settings to highlight merchandise, and/or in games to highlight physical objects of focus within the game.

In some embodiments, the system 10 can be configured to emulate a computer assisted virtual environment (CAVE) virtual environment for a room with a small number of access network light fixtures 12. All four walls of the room, as well as the floor and the ceiling of the room can be “painted” with high definition (HD) video images. Advantageously, HD projectors 40 can be used that do not require huge space behind the walls (and often on the floors above and below too) to house the rear projection equipment needed in traditional CAVEs.

Hence, rendering information can be automatically calculated based on an analysis of a room scene captured by one or more access network light fixtures 12. Then, the rendering information can be calculated to control emissions projected by the one or more access network light fixtures 12 and tailored to the room scene.

Any of the disclosed circuits of the devices 12, 32, 50, and/or 60 (including the network interface circuit 44, the processor circuit 46, the memory circuit 48, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit (e.g., within the memory circuit 48) causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 48 can be implemented, for example, using a non-volatile memory such as a programmable read only memory (PROM) or an EPROM, rotating disk, and/or a volatile memory such as a DRAM, etc.

The operations described with respect to any of the Figures can be performed in any suitable order, or at least some of the operations in parallel. Execution of the operations as described herein is by way of illustration only; as such, the operations do not necessarily need to be executed by the machine-based hardware components as described herein; to the contrary, other machine-based hardware components can be used to execute the disclosed operations in any appropriate order, or at least some of the operations in parallel.

Further, any reference to “outputting a message” or “outputting a packet” (or the like) can be implemented based on creating the message/packet in the form of a data structure and storing that data structure in a non-transitory tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the non-transitory tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a non-transitory tangible memory medium in the disclosed apparatus (e.g., in a receive buffer). Also note that the memory circuit 48 can be implemented dynamically by the processor circuit 46, for example based on memory address assignment and partitioning executed by the processor circuit 46.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
transmitting, by an access network light fixture, scene information to a light fixture control server, the scene information being associated with a scene detected by one or more cameras associated with the access network light fixture, the scene being within a vicinity of the access network light fixture;
receiving, by the access network light fixture, rendering information based on the scene information from the light fixture control server; and
controlling, by the access network light fixture, projection of an image overlying the scene and projected by one or more image projectors associated with the access network light fixture based on the rendering information received from the light fixture control server.

2. The method of claim 1, further comprising:
detecting, at the access network light fixture, a shadow within the vicinity of the access network light fixture;
wherein the rendering information comprises a correction to compensate for the shadow.

3. The method of claim 1, further comprising:
detecting, at the access network light fixture, a sound within the vicinity of the access network light fixture;
wherein the scene information comprises sound information associated with the sound.

4. The method of claim 1, further comprising:
detecting, by the access network light fixture, glare on an object within the vicinity of the access network light fixture; and
wherein the rendering information comprises a correction to compensate for the glare.

5. The method of claim 1, further comprising aligning projection of the image overlying the scene with another image projected by another access network light fixture by calibrating the one or more image projectors.

6. The method of claim 1, further comprising:
detecting, by the access network light fixture, a user gesture within the vicinity of the access network light fixture;
wherein the rendering information controls projection of the image responsive to the user gesture.

7. An apparatus comprising:
a network interface circuit configured to establish communications between an access network light fixture and a light fixture control server; and
a processor circuit configured to control transmission of scene information associated with a scene within a vicinity of the access network light fixture to the light fixture control server, reception of rendering information based on the scene information from the light fixture control server, and projection of an image overlying the scene and projected by one or more image projectors associated with the access network light fixture based on the rendering information received from the light fixture control server.

8. The apparatus of claim 7, wherein the processor circuit is further configured to control transmission of sound information associated with a sound within a vicinity of the access network light fixture to the light fixture control server, wherein the rendering information is based on the sound information and the projection of the image is in response to the sound detected as being an audible command.

9. The apparatus of claim 7, wherein the processor circuit is further configured to control transmission of glare information associated with glare on an object within the vicinity of the access network light fixture to the light fixture control server, wherein the rendering information is based on correcting for the glare information.

10. The apparatus of claim 7, wherein the processor circuit is further configured to control calibration of the image projectors to align projection of the image overlying the scene with another image projected by another access network light fixture.

11. The apparatus of claim 7, wherein the processor circuit is further configured to control transmission of gesture information associated with a user gesture within the vicinity of the access network light fixture to the light fixture control server, wherein the rendering information is based on the gesture information and the projection is based on the gesture information.

12. Logic encoded in one or more non-transitory tangible media for execution by a machine and when executed by the machine operable for:
transmitting, by an access network light fixture, scene information to a light fixture control server, the scene information being associated with a scene detected by one or more cameras associated with the access network light fixture, the scene being within a vicinity of the access network light fixture;
receiving, by the access network light fixture, rendering information based on the scene information from the light fixture control server; and
controlling, by the access network light fixture, projection of an image overlying the scene and projected by one or more image projectors associated with the access network light fixture based on the rendering information received from the light fixture control server.

13. A method comprising:
receiving, at a light fixture control server, scene information associated with a scene detected by one or more cameras within a vicinity of an access network light fixture;
determining, at the light fixture control server, rendering information based on the scene information, the rendering information controlling projection of an image overlying the scene and projected by one or more image projectors associated with the access network light fixture; and
transmitting, by the light fixture control server, the rendering information to the access network light fixture.

14. The method of claim 13, further comprising:
receiving, at the light fixture control server, sound information associated a sound detected by a microphone within the vicinity of the access network light fixture; and
determining, at the light fixture control server, the rendering information based on the sound information detected as being an audible command.

15. The method of claim 13, further comprising:
receiving, at the light fixture control server, scene information associated with a shadow detected by the one or more cameras within the vicinity of the access network light fixture; and
determining, at the light fixture control server, the rendering information based on the shadow.

16. An apparatus comprising:
a network interface circuit configured to establish communications between an access network light fixture and a light fixture control server; and
a processor circuit configured to control reception of scene information associated a scene detected by one or more cameras within a vicinity of an access network light fixture, determination of rendering information based on the scene information, and transmission of the rendering information to the access network light fixture, the rendering information controlling projection of an image overlying the scene and projected by one or more image projectors associated with the access network light fixture.

17. The apparatus of claim 16, wherein the processor circuit is further configured to control reception of sound information associated with a sound detected within the vicinity of the access network light fixture by a microphone, determination of the rendering information based on the sound information detected as being an audible command.

18. The apparatus of claim 16, wherein the processor circuit is further configured to control reception of the scene information associated with a shadow detected within the vicinity of the access network light fixture by the one or more cameras, and determine the rendering information based on the shadow.

19. The apparatus of claim 16, wherein the processor circuit is further configured to control reception of glare information associated with glare detected within the vicinity of the access network light fixture by the one or more cameras, and determination of the rendering information based on correcting for the glare information.

20. Logic encoded in one or more non-transitory tangible media for execution by a machine and when executed by the machine operable for:
receiving, at a light fixture control server, scene information associated with a scene detected by one or more cameras within a vicinity of an access network light fixture;
determining, at the light fixture control server, rendering information based on the scene information, the rendering information controlling projection of an image overlying the scene and projected by one or more image projectors associated with the access network light fixture; and
transmitting, by the light fixture control server, the rendering information to the access network light fixture.
